(19) United States
(12) Patent Application Publication
(10) Pub. No.: US 2007/0007399 A1
(43) Pub. Date: Jan. 11, 2007

(54) Electronic apparatus with optical module having muscles suppleness effect by emitting light rays into hand and wrist operating thereon

(75) Inventors: Ling-Ling Cheng, Taipei (TW); Kuo-Yang Cheng, Taipei (TW); Ming-Hui Chen, Taipei (TW); Wei-Huan Chou, Taipei (TW); Kai-Chen Tien, Taipei (TW); Chi-Fen Chang, Taipei (TW)

Correspondence Address: BACON & THOMAS, PLLC, 625 SLATERS LANE, FOURTH FLOOR, ALEXANDRIA, VA, 22314, US

(73) Assignee: INVENTEC CORPORATION, Taipei (TW)

(21) Appl. No.: 11/144,653

(22) Filed: Jun. 6, 2005

(51) Int. Cl. B43L 15/00

(52) U.S. Cl. 248/118.1

(57) ABSTRACT

The present invention is to provide an electronic apparatus comprising one or two palm rests including an internal first connector and a transparent top surface for supporting hand and wrist of a user using the electronic apparatus, and one or two optical modules each disposed under the palm rest, wherein the optical module includes a PCB, a plurality of spaced LEDs arranged in a predetermined form on the PCB, and a second connector electrically connected to the first connector and being served as a power input for enabling the LEDs to emit light rays into the hand and wrist through the top surface of each palm rest for making muscles of the hand and the wrist supple.

### FIELD OF THE INVENTION

The present invention relates to devices for increasing muscles suppleness and more particularly to an optical module mounted in an electronic apparatus (e.g., notebook, keyboard, or mouse), the optical module being adapted to emit light rays into hand and wrist of a user while using the electronic apparatus so as to make muscles of the hand and wrist supple.

### BACKGROUND OF THE INVENTION

Modern life is bustling due to fast changes of society. Many people suffer great stress from society, school, and/or family. Thus, many people have mental disorders such as worries, rage, depression, anxiety, scare, loneliness, lack of safety, seclusion, etc. Such mental disorders can adversely affect immunity and antibody of human being. Thus, a person having one or more such mental disorders is susceptible to diseases. This kind of disease is referred to physiological-psychological disease.

Moreover, it is often heard that a person suffers musculoskeletal discomfort (e.g., soreness, stiffness, injuries, or even disease) in his/her hand and wrist due to long periods of time of using an electronic apparatus (e.g., notebook, keyboard, or mouse). It is also known that light rays of a specific wavelength can increase metabolism, increase blood circulation, etc. when it penetrates the body as disclosed in medical journals. One of the light rays is pulse light having a specific wavelength capable of increasing blood circulation, making muscles supple, decreasing muscle soreness, etc. when it penetrates the body. In addition, a human cell can emit weak light rays to communicate with another. Disease and/or metal disorders can occur if such communication is blocked.

A well-known biological light energy balancer is characterized in that it can emit light of a specific color by vibration into the body. Thus, the weak light (e.g., biological proton) emitted by the cells can be enhanced. This is a natural treatment for enabling a person to feel well both physically and mentally without causing pain by intrusion. In brief, it has the following effects including immune system enhancement, exhaust of toxin from the body, hormone production increase, treatment of chronic disease, and healing of mental disorders and diseases such as stress, insomnia, sex problem, and blood circulation problem.

For quick treatment, typical optical devices for medical treatment may emit pulse light in a high power operating environment. However, it is also very risky.

In view of the fact that the times of people using such electronic apparatus is very high (i.e., frequently used). It is impossible of doing without them in our daily life and work. Thus, a person suffering musculoskeletal discomfort (e.g., soreness or the like) in his/her hand and wrist due to long periods of time of using the notebook is not avoidable. Fortunately, the present inventor is aware of this existing problem and thus contemplates to devise an optical module having muscles suppleness effect mounted in the electronic apparatus, the optical module being adapted to emit light rays into the hand and the wrist while using the electronic apparatus so as to make muscles of the hand and the wrist supple. This is particularly beneficial to persons using the electronic apparatus for long periods of time. Moreover, a manufacturer of the electronic apparatus incorporating the optical module thus can survive in the competitive market of such electronic apparatus.

### SUMMARY OF THE INVENTION

In view of the above, it is understood that many people suffer musculoskeletal discomfort (e.g., soreness, stiffness, or the like) in hand and wrist of a user due to long periods of time of using an electronic apparatus (e.g., notebook, keyboard, or mouse). Also, a pulse light having a specific wavelength capable of increasing blood circulation, making muscles supple, decreasing muscle soreness, etc. when it penetrates the body. The present inventor is aware of this existing problem and is thus dedicated to meet market demand and user needs. After considerable research and experimentation, an electronic apparatus with an optical module having muscles suppleness effect by emitting light rays into the hand and the wrist operating thereon according to the present invention has been devised so as to overcome the above problem. The electronic apparatus comprises one or two palm rests for supporting the hands and the wrists of a user using the electronic apparatus, and one or two optical modules each disposed under the palm rest, the optical module being adapted to emit light rays into each hand and each wrist through each palm rest for making muscles of the hand and the wrist supple. Thus, musculoskeletal discomfort (e.g., soreness, stiffness, or the like) in the hand and the wrist due to long periods of time of using the electronic apparatus is greatly improved.

It is an object of the present invention to provide an electronic apparatus (e.g., notebook, keyboard, or mouse) having an arrangement for making muscles of the hand and the wrist supple rather than making muscles thereof sore and stiff. For achieving the above object, the electronic apparatus comprises one or two palm rests for supporting the hands and the wrists of a user using the electronic apparatus, the palm rest including an internal first connector and a transparent top surface; and one or two optical modules each disposed under the palm rest, the optical module including a PCB, a plurality of spaced LEDs arranged in a predetermined form on the PCB, and a second connector electrically connected to the first connector, the second connector being served as a power input for enabling the LEDs to emit light rays into each hand and each wrist through the top surface of each palm rest for making muscles of the hand and the wrist supple. By utilizing this electronic apparatus, musculoskeletal discomfort (e.g., soreness, stiffness, or the like) in the hand and the wrist due to long periods of time of using the electronic apparatus is greatly improved.

In one aspect of the present invention, the electronic apparatus is a notebook and the palm rests for supporting the hands and the wrists are disposed behind a set of keys on the housing and to the right and the left of a touch pad on the housing respectively, the optical module further comprises a separate, connectable cassette, the cassette being adapted to insert into a cassette slot of the palm rest for connecting the second connector to the first connector at a blind end of the cassette slot, and a top surface of the cassette corresponding to the top surface of the palm rest is formed of transparent material.

In another aspect of the present invention, the electronic apparatus is a keyboard and the palm rests for supporting the hands and the wrists are disposed behind a set of keys thereof and proximate both sides of the keyboard.

In yet another aspect of the present invention, the electronic apparatus is a mouse, the palm rest for supporting the hand and the wrist, the palm rest is disposed along a lengthwise, central line on an arc top surface of the mouse, and the PCB of the optical module is a FPC for accommodating the arc top surface of the mouse.

The above and other objects, features and advantages of the present invention will become apparent from the following detailed description taken with the accompanying drawings.

### BRIEF DESCRIPTION OF THE DRAWINGS

FIG. 1 is a perspective view of a notebook incorporating an optical module according to a first preferred embodiment of the invention, where the notebook is open;

FIG. 2 is a perspective view of a keyboard incorporating an optical module according to a second preferred embodiment of the invention; and

FIG. 3 is a perspective view of a mouse incorporating an optical module according to a third preferred embodiment of the invention.

### DETAILED DESCRIPTION OF THE PREFERRED EMBODIMENTS

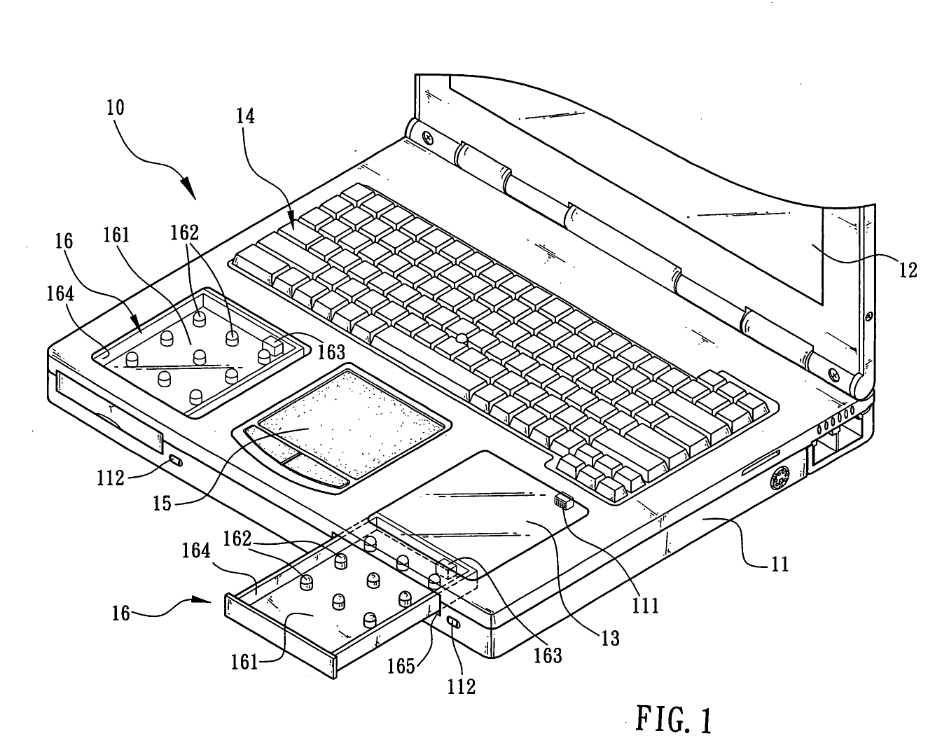

The invention is directed to an electronic apparatus with an optical module having muscles suppleness effect by emitting light rays into the hand and the wrist operating thereon. The electronic apparatus comprises one or two palm rests for supporting the hands and the wrists of a user using the electronic apparatus, the palm rest including a transparent top surface for permitting red light or infrared light to penetrate; and one or two optical modules each disposed under the palm rest, the optical module including a light source (e.g., a plurality of spaced light emitting diodes (LEDs) of low power arranged in a predetermined form, the LEDs being adapted to emit light rays having a wavelength of 940 nm), wherein the LEDs are adapted to emit light rays into each hand and each wrist through the top surface of each palm rest for making muscles of the hand and the wrist supple. By utilizing the invention, musculoskeletal discomfort (e.g., soreness, stiffness, or the like) in the hand and the wrist due to long periods of time of using the electronic apparatus is greatly improved. Referring to FIG. 1, a first preferred embodiment incorporating the above characteristics of the invention is detailed below.

The electronic apparatus is implemented as a notebook 10 including a housing 11 and a screen 12 hingedly attached thereto. The notebook 10 comprises two palm rests 13 for supporting the hands and the wrists. The palm rests 13 are disposed behind a set of keys 14 and to the right and the left of a touch pad 15 respectively. Two optical modules 16 having muscles suppleness effect are provided and each is disposed under the palm rest 13. The optical module 16 comprises a printed circuit board (PCB) 161, a plurality of spaced LEDs 162 arranged in rows on the PCB 161, a second connector 163, and associated resistors and capacitors (not shown). The LED 162 is adapted to emit low power, low energy light rays of narrow frequency such as red light or near infrared light which is one of invisible rays. Thus, another light source may be added in the near infrared light as indicator or flashlight for enhanced visual effect. The LED 162 for medical treatment is implemented as dual inline package (DIP) or surface mount technology (SMT). LED 162 in the form of SMT has a low power and a small effective light emitting range. In the first preferred embodiment shown in FIG. 1, the LED 162 is implemented as DIP. Also, the number of LEDs 162 and its density depend on power consumption, performance, and cost. The second connector 163 is electrically connected to a first connector 161 in the palm rest 13 and thus serves as power input for enabling the LEDs 162 to emit light.

Moreover, in the first preferred embodiment of FIG. 1, the optical module 16 further comprises a separate but connectable cassette 164 which can be removed by pulling similar to a typical CD-ROM drive. The separate cassette 164 is adapted to insert into a cassette slot 165 of the palm rest 13 for connecting the rear second connector 163 to the first connector 111 at the blind end of the cassette slot 165. Top surface of the cassette 164 corresponding to a top surface of the palm rest 13 is formed of transparent material. Further, a switch 112 is provided on a front panel of the housing 11 for controlling an on or off of the optical module 16. It is understood that power can be saved if the optical module 16 is in a disabled state.

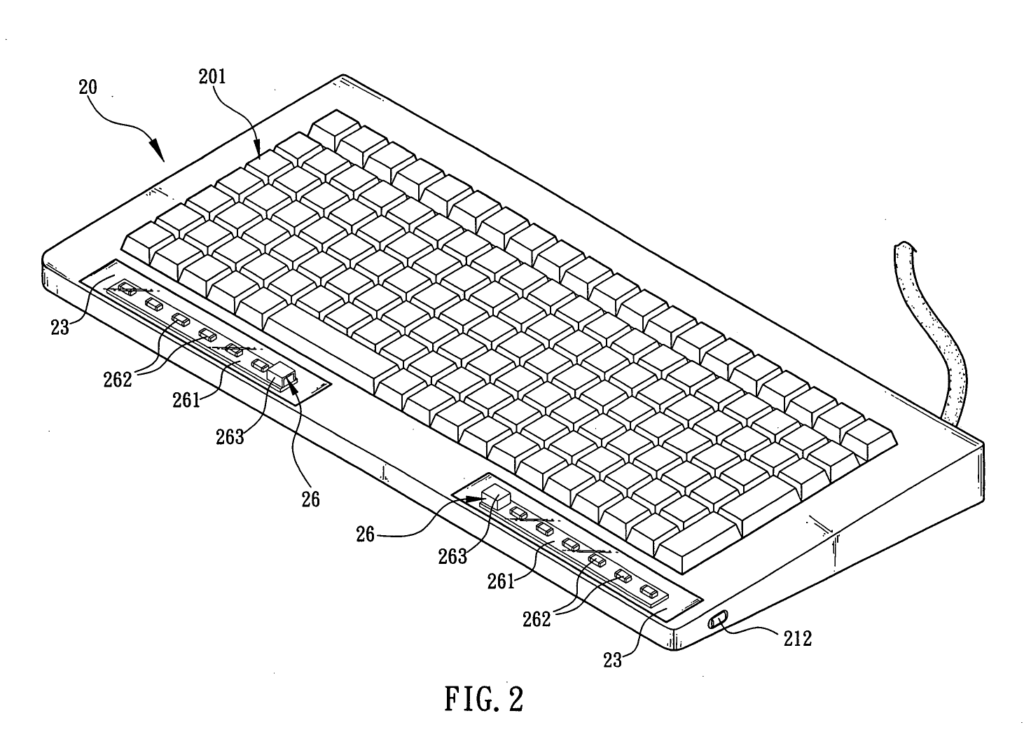

Referring to FIG. 2, a second preferred embodiment incorporating the above characteristics of the invention is detailed below.

The electronic apparatus is implemented as a keyboard 20 including two palm rests 23 for supporting the hands and the wrists. The spaced palm rests 23 are disposed behind a set of keys 201 at the right and the left of the keyboard 20 respectively. Two optical modules 26 having muscles suppleness effect are provided and each is disposed under the palm rest 23. The optical module 26 comprises a PCB 261, a plurality of spaced LEDs 262 arranged in a row on the PCB 261, a second connector 263, and associated resistors and capacitors (not shown). The second connector 263 is electrically connected to a first connector in the palm rest 23. The first connector is not shown in FIG. 2 because it is electrically connected to the second connector 263. The second connector 263 thus serves as power input for enabling the LEDs 262 to emit light. Moreover, in the second preferred embodiment of FIG. 2, the LED 262 is implemented in the form of SMT. Further, a switch 212 is provided on a side of the keyboard 20 for controlling an on or off of the optical module 26. It is understood that power can be saved if the optical module 26 is in a disabled state.

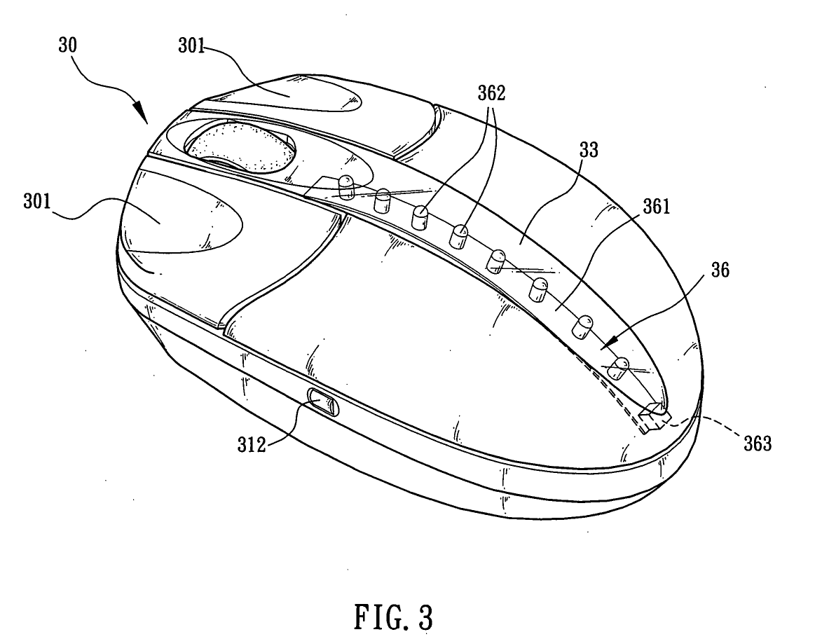

Referring to FIG. 3, a third preferred embodiment incorporating the above characteristics of the invention is detailed below.

The electronic apparatus is implemented as a mouse 30 including a palm rest 33 for supporting the hand and the wrist. The palm rest 33 is disposed along a lengthwise, central line on an arc top surface of the mouse 30 and is also disposed between two top buttons 301. An optical module 36 having muscles suppleness effect is provided under the palm rest 33. The optical module 36 comprises a PCB 361, a plurality of spaced LEDs 362 arranged in a row on the PCB 361, a second connector 363, and associated resistors and capacitors (not shown). The second connector 363 is electrically connected to a first connector in the palm rest 33. The first connector is not shown in FIG. 3 because it is electrically connected to the second connector 363. The second connector 363 thus serves as power input for enabling the LEDs 362 to emit light. In addition, the PCB 361 of the optical module 36 is implemented as a flexible printed circuit (FPC) for accommodating the arc top surface of the mouse 30, and is fixed by a support (not shown) thereunder. Moreover, in the third preferred embodiment of FIG. 3, the LED 362 is implemented in the form of DIP. Further, a switch 312 is provided on a side of the mouse 30 for controlling an on or off of the optical module 36. It is understood that power can be saved if the optical module 36 is in a disabled state.

Referring to FIGS. 1, 2, and 3 again, it is understood that either the hands and the wrists are placed on the palm rests 13 of the notebook 10 or the palm rests 23 of the keyboard 20 when a user is using the notebook 10 or the keyboard 20 or the hand and the wrist are placed on the palm rest 33 of the mouse 30 when the user is using the mouse 30. The LEDS 162, 262, or 362 of each optical module 16, 26, or 36 are enabled to emit light into the hand and the wrist. As a result, blood circulation in the muscles of the hand and the wrist is increased, musculoskeletal discomfort (e.g., soreness and stiffness) in the muscles of the hand and the wrist is improved, and pain in the muscles of the hand and the wrist is also released. Moreover, the LEDs 162, 262, and 362 are adapted to emit low energy light rays of narrow frequency or electro-luminescence such that the user suffers neither burning heat nor pain. As a result, the user is prevented from being hurt.

As contemplated by the invention, as compared with a typical optical device for medical treatment, the invention can save time of waiting the hand and the wrist to recover from fatigue and thus save money. Moreover, possibility of causing musculoskeletal discomfort in the hand and the wrist due to long periods of time of using a set of keys 14 on a notebook 10 or a keyboard 20, or a mouse 30 is greatly reduced. Further, the invention is structurally simple and is able to eliminate drawbacks associated with the prior art. As an end, a notebook 10, keyboard 20, or mouse 30 incorporating the invention can increase its competitiveness in the market of such product. Indeed, the invention is an ergonomic design.

While the invention herein disclosed has been described by means of specific embodiments, numerous modifications and variations could be made thereto by those skilled in the art without departing from the scope and spirit of the invention set forth in the claims.

What is claimed is:

1. An electronic apparatus comprising:
one or two palm rests for supporting hands and wrists of a user using the electronic apparatus, the palm rest including an internal first connector and a transparent top surface; and
one or two optical modules each disposed under the palm rest, the optical module including a printed circuit board (PCB), a plurality of spaced light emitting diodes (LEDs) arranged in a predetermined form on the PCB, and a second connector electrically connected to the first connector, the second connector being served as a power input for enabling the LEDs to emit light rays into each hand and each wrist through the top surface of each palm rest for making muscles of the hand and the wrist supple.

2. The electronic apparatus of claim 1, wherein the electronic apparatus is a notebook including a housing and a screen hingedly attached thereto, and wherein the palm rests are disposed behind a set of keys on the housing and to the right and the left of a touch pad on the housing respectively.

3. The electronic apparatus of claim 2, wherein the optical module further comprises a separable cassette, the cassette being adapted to insert into a cassette slot of the palm rest for connecting the second connector to the first connector at a blind end of the cassette slot, and wherein a top surface of the cassette corresponding to the top surface of the palm rest is formed of transparent material.

4. The electronic apparatus of claim 1, wherein the LED is adapted to emit low power, low energy light rays of narrow frequency in the form of red light or near infrared light, and wherein another light source is adapted to add in the near infrared light as an indicator or a flash light for enhanced visual effect.

5. The electronic apparatus of claim 1, wherein the electronic apparatus is a keyboard including two palm rests for supporting the hands and the wrists, the spaced palm rests being disposed behind a set of keys thereof and proximate both sides of the keyboard.

6. The electronic apparatus of claim 1, wherein the electronic apparatus is a mouse including a palm rest for supporting the hand and the wrist, the palm rest being disposed along a lengthwise, central line on an arc top surface of the mouse.

7. The electronic apparatus of claim 6, wherein the PCB of the optical module is a flexible printed circuit (FPC) for accommodating the arc top surface of the mouse.

8. The electronic apparatus of claim 2, further comprising a switch provided on a predetermined position thereof for controlling an on or off of the optical module and saving power when the optical module is disabled.

9. The electronic apparatus of claim 5, further comprising a switch provided on a predetermined position thereof for controlling an on or off of the optical module and saving power when the optical module is disabled.

10. The electronic apparatus of claim 6, further comprising a switch provided on a predetermined position thereof for controlling an on or off of the optical module and saving power when the optical module is disabled.
